(19) United States
(12) Patent Application Publication
(10) Pub. No.: US 2003/0118497 A1
(43) Pub. Date: Jun. 26, 2003

(54) Support for use in catalyst for producing lower aliphatic carboxylic acid ester, catalyst for producing lower aliphatic carboxylic acid ester using the support, process for producing the catalyst, and process for producing lower aliphatic carboxylic acid ester using the catalyst

(76) Inventors: Etsuko Kadowaki, Oita (JP); Kousuke Narumi, Oita (JP); Hiroshi Uchida, Oita (JP)

Correspondence Address: SUGHRUE MION, PLLC, 2100 PENNSYLVANIA AVENUE, N.W., WASHINGTON, DC, 20037, US

(21) Appl. No.: 10/070,259

(22) PCT Filed: Feb. 12, 2002
(86) PCT No.: PCT/JP02/01156

(30) Foreign Application Priority Data
Feb. 13, 2001 (JP) 2001-036038
Dec. 7, 2001 (JP) 2001-373675

(51) Int. Cl. C01B 33/12; B01J 21/08; B01J 27/18

(52) U.S. Cl. 423/335; 502/208; 502/209; 502/210; 502/211; 502/232; 502/240; 502/247; 502/254

(57) ABSTRACT

A siliceous support for use in a catalyst for producing a lower aliphatic carboxylic acid ester by reacting a lower olefin with a lower aliphatic carboxylic acid in a gas phase, which has a silicon content of from 39.7 to 46.3% by mass or a silicon content of from 85 to 99% by mass in terms of silicon dioxide or a crush strength of 30 N or more. By the use of a catalyst comprising the support, a lower aliphatic carboxylic acid ester is produced from lower olefin and a lower aliphatic carboxylic acid without causing great reduction of catalytic activity or cracking or abrasion of the catalyst.

### CROSS-REFERENCE TO RELATED APPLICATION

This application is an application filed under 35 U.S.C. §111(a) claiming benefit pursuant to 35 U.S.C. §119(e)(1) of the filing date of the Provisional Application No. 60/273,343 filed Mar. 6, 2001, pursuant to 35 §111(b).

### TECHNICAL FIELD

The present invention relates to a support for use in a catalyst for producing a lower aliphatic carboxylic acid ester; a catalyst for producing a lower aliphatic carboxylic acid ester using the support; a process for producing the catalyst; and a process for producing a lower aliphatic carboxylic acid ester using the catalyst. More specifically, the present invention relates to a siliceous support for use in a catalyst for producing a lower aliphatic carboxylic acid ester from a lower olefin and a lower aliphatic carboxylic acid; a catalyst for producing a lower aliphatic carboxylic acid ester using the support; a process for producing the catalyst; and a process for producing a lower aliphatic carboxylic acid ester using the catalyst.

### BACKGROUND ART

As is well known, a corresponding ester can be produced from a lower aliphatic carboxylic acid and an olefin by a gas phase catalytic reaction. Also, a catalyst comprising a heteropolyacid and/or a heteropolyacid salt and supported on a siliceous support is known to be useful in such a reaction. The siliceous support used here is known as a silica support. Specific examples of recent publications disclosing this technique include Japanese Unexamined Patent Publication No. 11-269126 (JP-A-11-269126) and Japanese Unexamined Patent Publication No. 11-263748 (JP-A-11-263748).

JP-A-11-269126 and JP-A-11-263748 disclose a technique of producing a lower aliphatic carboxylic acid ester by contacting a lower aliphatic carboxylic acid and a lower olefin with a heteropolyacid supported on a silica support (siliceous support) in a gas phase. In these patent publications, it is stated that, to achieve optimal performance, the silica support preferably has a purity of 99% by weight or more, because impurities may adversely affect the catalytic activity. As such, the siliceous support used as a support for improving the catalytic activity preferably has a high silicon purity. However, siliceous supports having a high silicon purity suffer from a very low strength and if a catalyst using such a support having a low strength is used, cracking may be generated at the preparation of the catalyst, or cracking or abrasion of the catalyst may be generated according to the amount of use in the production of esters, giving rise to an increase in the pressure loss of a reactor and, in turn, to failure of safe operation.

### DISCLOSURE OF INVENTION

The object of the present invention is to provide a support capable of providing a stably operable catalyst, for producing a lower aliphatic carboxylic acid ester, which prevents a great reduction in the catalytic activity and protects the catalyst from cracking or abrasion during the production of a lower aliphatic carboxylic acid ester, wherein the catalyst is supported on a siliceous support and used in the production of a lower aliphatic carboxylic acid ester from a lower olefin and a lower aliphatic carboxylic acid. The object of the present invention includes providing a catalyst for producing a lower aliphatic carboxylic acid ester using the support, a process for producing the catalyst and a process for producing a lower aliphatic carboxylic acid ester using the catalyst.

To attain the above-described objects, the present invention provides a siliceous support for use in a catalyst for producing a lower aliphatic carboxylic acid ester by reacting a lower olefin with a lower aliphatic carboxylic acid in a gas phase, which has a silicon content of from 39.7 to 46.3% by mass.

The present invention also provides a siliceous support for use in a catalyst for producing a lower aliphatic carboxylic acid ester by reacting a lower olefin with a lower aliphatic carboxylic acid in a gas phase, which has a silicon content of from 85 to 99% by mass in terms of silicon dioxide.

The present invention also provides a siliceous support for use in a catalyst for producing a lower aliphatic carboxylic acid ester by reacting a lower olefin with a lower aliphatic carboxylic acid in a gas phase, which has a crush strength of 30 N or more.

The present invention also provides a catalyst supported on a support, which is a catalyst for producing a lower aliphatic carboxylic acid ester by reacting a lower olefin with a lower aliphatic carboxylic acid in a gas phase, wherein the support is any one of the above-described supports of the present invention.

The present invention also provides a process for producing a catalyst for producing a lower aliphatic carboxylic acid ester by reacting a lower olefin with a lower aliphatic carboxylic acid in a gas phase, the process comprising a step of loading at least one member selected from the group consisting of heteropolyacids and salts thereof on any one of the above-described supports of the present invention.

The present invention also provides a process for producing a catalyst for producing a lower aliphatic carboxylic acid ester by reacting a lower olefin with a lower aliphatic carboxylic acid in a gas phase, the process comprising the following first and second steps:

First Step:

a step of loading at least one member selected from the group consisting of heteropolyacids and salts thereof on any one of the above-described supports of the present invention to obtain a heteropolyacid and/or heteropolyacid salt-supported catalyst;

Second Step:

a step of contacting the heteropolyacid and/or heteropolyacid salt-supported catalyst obtained in the first step with a gas containing at least one member selected from the group consisting of water, lower aliphatic carboxylic acids and lower aliphatic alcohols to obtain a catalyst for producing a lower aliphatic carboxylic acid ester.

The present invention also provides a process for producing a lower aliphatic carboxylic acid ester, comprising reacting a lower olefin with a lower aliphatic carboxylic acid in a gas phase in the presence of the above-described catalyst for producing a lower aliphatic carboxylic acid ester of the present invention.

### BRIEF DESCRIPTION OF DRAWINGS

FIG. 1 is a graph showing the crush strength and the specific activity with respect to the silica content of the support in catalysts used in Examples of the present invention and Comparative Examples.

### BEST MODE FOR CARRYING OUT THE INVENTION

The present inventors have made extensive investigations for a catalyst supported on a siliceous support and used in the production of a lower aliphatic carboxylic acid ester from a lower olefin and a lower aliphatic carboxylic acid, which can prevent a great reduction in the catalytic activity, is protected from cracking or abrasion during the production of a lower aliphatic carboxylic acid ester and can ensure stable operation. As a result, it has been found that the crush strength of a catalyst is closely related to the silicon purity of a siliceous support and when the content of silicon in the siliceous support falls within a predetermined range, the obtained catalyst for producing a lower aliphatic carboxylic acid ester can prevent a great reduction in the catalytic activity, is protected from cracking or abrasion during the production of a lower aliphatic carboxylic acid ester and can be stably operated. The present invention has been accomplished based on this finding.

In the siliceous support of the present invention, the silicon content is from 39.7 to 46.3% by mass (from 85 to 99% by mass in terms of silicon dioxide), preferably from 41.1 to 46.3% by mass (from 88 to 99% by mass in terms of silicon dioxide), more preferably from 42.1 to 46.3% by mass (from 90 to 99% by mass in terms of silicon dioxide). According to the present invention, the support having a silicon content within the above-described range is found to have a crush strength of 30 N or more, whereby the objects of the present invention can be attained.

The silicon content of the support can be measured by a chemical analysis such as inductively coupled plasma emission spectrometry (ICP), fluorescent x-ray spectrometry and atomic absorption spectrometry. In these methods, the silicon content is generally measured as a silicon dioxide content. In the present invention, a silicon dioxide content measured by ICP out of these methods is preferably used, however, a value according to the value measured by other methods or a value obtained by extrapolating the measured value may also be used.

The process for producing the support of the present invention is not particularly limited and may be any process. Specific examples thereof are described in Zoryu Handbook (Granulation Handbook), edited by Nippon Funtai Kogyo Gijutsu Kyokai, published by Ohm Kabushiki Kaisha on Mar. 10, 1991, pp.661-671, but are not limited thereto.

The support of the present invention is not limited on the shape thereof and may have any shape. For example, a support in a powder, a spherical, a pellet-like or any other arbitrary form may be used. A support having a spherical or a pellet-like form is preferred. Also, the particle size is not particularly limited. Although the preferred particle size varies depending on the reaction method, in the case of use in a fixed bed system, the particle size is preferably from 2 to 10 mm, more preferably from 3 to 7 mm, and in the case of use in a fluidized bed system, the preferred range is from a powder to a particle size of 5 mm, more preferably from powder to a particle size of 2 mm.

According to the present invention, a catalyst for producing a lower aliphatic carboxylic acid ester is also provided, which is supported on the above-described support of the present invention and is used for producing a lower aliphatic carboxylic acid ester by reacting a lower olefin with a lower aliphatic carboxylic acid in a gas phase. In this catalyst, a crush strength equal to the crush strength of the support can be maintained and therefore, the catalyst for producing a lower aliphatic carboxylic acid ester of the present invention also has a crush strength of 30 N or more.

The catalyst for producing a lower aliphatic carboxylic acid ester of the present invention can be produced, for example, by a process comprising a step of loading at least one member selected from heteropolyacids and salts thereof on the above-described support of the present invention.

The heteropolyacids which can be used in the production of the catalyst of the present invention comprise a center element and a peripheral element to which oxygen is bonded. The center element is usually silicon or phosphorus but may comprise an arbitrary element selected from various kinds of atoms belonging to Groups 1 to 17 of the Periodic Table. Specific examples thereof include cupric ion; divalent beryllium, zinc, cobalt and nickel ions; trivalent boron, aluminum, gallium, iron, cerium, arsenic, antimony, phosphorus, bismuth, chromium and rhodium ions; tetravalent silicon, germanium, tin, titanium, zirconium, vanadium, sulfur, tellurium, manganese, nickel, platinum, thorium, hafnium, cerium ions and other rare earth ions; pentavalent phosphorus, arsenic, vanadium and antimony ions; hexavalent tellurium ion; and heptavalent iodide ion, however, the present invention is by no means limited thereto. Specific examples of the peripheral element include tungsten, molybdenum, vanadium, niobium and tantalum, however, the present invention is by no means limited thereto.

These heteropolyacids are also known as a “polyoxo-anion”, a “polyoxometallic salt” or a “metal oxide cluster”. The structures of some well-known anions are named after the researcher in this field and called, for example, Keggin, Wells-Dawson or Anderson-Evans-Perloff structures. These are described in detail in Poly-San no Kagaku, Kikan Kagaku Sosetsu (Chemistry of Polyacids, Quarterly of Chemistry General View), No. 20, edited by Nippon Kagaku Kai (1993). The heteropolyacids usually have a high molecular weight, for example, a molecular weight of 700 to 8,500, and include not only the monomers but also dimeric complexes thereof.

Specific examples of the heteropolyacids include:

| | |
|---|---|
| Tungstosilicic acid | H₄[SiW₁₂O₄₀].xH₂O |
| Tungstophosphoric acid | H₃[PW₁₂O₄₀].xH₂O |
| Molybdophosphoric acid | H₃[PMO₁₂O₄₀].xH₂O |
| Molybdosilicic acid | H₄[SiMo₁₂O₄₀].xH₂O |
| Vanadotungstosilicic acid | H₄₊ₙ[SiVₙW₁₂₋ₙO₄₀].xH₂O |
| Vanadotungstophosphoric acid | H₃₊ₙ[PVₙW₁₂₋ₙO₄₀].xH₂O |
| Vanadomolybdophosphoric acid | H₃₊ₙ[PVₙMo₁₂₋ₙO₄₀].xH₂O |
| Vanadomolybdosilicic acid | H₄₊ₙ[SiVₙMO₁₂₋ₙO₄₀].xH₂O |
| Molybdotungstosilicic acid | H₄[SiMOₙW₁₂₋ₙO₄₀].xH₂O |
| Molybdotungstophosphoric acid | H₃[PMOₙW₁₂₋ₙO₄₀].xH₂O |

wherein n is an integer of 1 to 11 and x is an integer of 1 or more. However, the present invention is by no means limited thereto.

Among these, preferred are tungstosilicic acid, tungstophosphoric acid, molybdophosphoric acid, molybdosilicic acid, vanadotungstosilicic acid and vanadotungstophosphoric acid, more preferred are tungstosilicic acid, tungstophosphoric acid, vanadotungstosilicic acid and vanadotungstophosphoric acid.

The synthesis method for these heteropolyacids is not particularly limited and any method may be used. For example, the heteropolyacid may be obtained by heating an acidic aqueous solution containing a salt of molybdic acid or tungstic acid and a simple oxygen acid of hetero atom or a salt thereof (pH: about 1 to 2). For isolating the heteropolyacid compound from the aqueous heteropolyacid solution produced, a method of crystallizing and separating the compound in the form of a metal salt may be used. Specific examples thereof include those described in Shin Jikken Kagaku Koza 8, Muki Kagoubutsu no Gosei (III) (New Experimental Chemistry Course 8, Synthesis of Inorganic Compounds (III)), 3rd ed., page 1413, edited by Nippon Kagaku Kai, published by Maruzen on Aug. 20, 1984, however, the present invention is not limited thereto. The Keggin structure of the heteropolyacid synthesized may be identified by the chemical analysis or by the X-ray diffraction or UV or IR measurement.

The heteropolyacids, particularly in the case where the heteropolyacids are free acids or are some salts, have a relatively high solubility in polar solvents such as water and other oxygen-containing solvents, and the solubility can be controlled by appropriately selecting the counter ion.

The heteropolyacids can be loaded on a support by allowing a solution or suspension obtained by dissolving or suspending a heteropolyacid in a solvent, to be absorbed into the support.

The amount of a heteropolyacid supported is preferably from 10 to 150% by mass, more preferably from 30 to 100% by mass, based on the total weight of the support. If the heteropolyacid content is less than 10% by mass, the active component content of the catalyst is too small and the activity per unit weight of catalyst may disadvantageously decrease. If the heteropolyacid content exceeds 150% by mass, the effective pore volume decreases and, as a result, the effect of the increase in the supported amount may not be brought out and at the same time, coking is disadvantageously liable to occur to seriously shorten the catalyst life.

The heteropolyacid salts which can be used in the production of the catalyst of the present invention may be a metal salt or an onium salt resulting from substituting a part or all of the hydrogen atoms of a heteropolyacid. Specific examples thereof include metal salts such as lithium, sodium, magnesium, barium, copper, gold and gallium, and onium salts, however, the present invention is not limited thereto. Among these, lithium salts, sodium salts, gallium salts, copper salts and gold salts are preferred, and lithium salts, sodium salts and copper salts are more preferred.

Examples of the starting material for the element of forming a heteropolyacid salt include lithium nitrate, lithium acetate, lithium sulfate, lithium sulfite, lithium carbonate, lithium phosphate, lithium oxalate, lithium nitrite, lithium chloride, lithium citrate, sodium nitrate, sodium acetate, sodium sulfate, sodium carbonate, monosodium phosphate, disodium phosphate, sodium oxalate, sodium nitrite, sodium chloride, sodium citrate, magnesium nitrate hexahydrate, magnesium acetate tetrahydrate, magnesium sulfate, magnesium carbonate, magnesium phosphate tricosahydrate, magnesium oxalate dihydrate, magnesium chloride, magnesium citrate, barium nitrate, barium acetate, barium sulfate, barium carbonate, barium hydrogenphosphate, barium oxalate monohydrate, barium sulfite, barium chloride, barium citrate, copper nitrate, copper acetate, copper sulfate, copper carbonate, copper diphosphate, copper oxalate, copper chloride, copper citrate, aurous chloride, chloroauric acid, auric oxide, auric hydroxide, auric sulfide, aurous sulfide, gallium dichloride, gallium monochloride, gallium citrate, gallium acetate, gallium nitrate, gallium sulfate, gallium phosphate, ammonium acetate, ammonium carbonate, ammonium nitrate, ammonium dihydrogenphosphate, ammonium hydrogencarbonate, ammonium citrate, ammonium nitrate, diammonium phosphate, monoammonium phosphate and ammonium sulfate, however, the present invention is by no means limited thereto.

Among these, preferred are lithium nitrate, lithium acetate, lithium carbonate, lithium oxalate, lithium citrate, sodium nitrate, sodium acetate, sodium carbonate, sodium oxalate, sodium citrate, copper nitrate, copper acetate, copper carbonate, copper citrate, aurous chloride, chloroauric acid, gallium citrate, gallium acetate and gallium nitrate, and more preferred are lithium nitrate, lithium-acetate, lithium carbonate, lithium oxalate, lithium citrate, sodium nitrate, sodium acetate, sodium carbonate, sodium oxalate, sodium citrate, copper nitrate, copper acetate, copper carbonate and copper citrate.

Specific examples of the heteropolyacid salts include lithium salt of tungstosilicic acid, sodium salt of tungstosilicic acid, copper salt of tungstosilicic acid, gold salt of tungstosilicic acid, gallium salt of tungstosilicic acid, lithium salt of tungstophosphoric acid, sodium salt of tungstophosphoric acid, copper salt of tungstophosphoric acid, gold salt of tungstophosphoric acid, gallium salt of tungstophosphoric acid, lithium salt of molybdophosphoric acid, sodium salt of molybdophosphoric acid, copper salt of molybdophosphoric acid, gold salt of molybdophosphoric acid, gallium salt of molybdophosphoric acid, lithium salt of molybdosilicic acid, sodium salt of molybdosilicic acid, copper salt of molybdosilicic acid, gold salt of molybdosilicic acid, gallium salt of molybdosilicic acid, lithium salt of vanadotungstosilicic acid, sodium salt of vanadotungstosilicic acid, copper salt of vanadotungstosilicic acid, gold salt of vanadotungstosilicic acid, gallium salt of vanadotungstosilicic acid, lithium salt of vanadotungstophosphoric acid, sodium salt of vanadotungstophosphoric acid, copper salt of vanadotungstophosphoric acid, gold salt of vanadotungstophosphoric acid, gallium salt of vanadotungstophosphoric acid, lithium salt of vanadomolybdophosphoric acid, sodium salt of vanadomolybdophosphoric acid, copper salt of vanadomolybdophosphoric acid, gold salt of vanadomolybdophosphoric acid, gallium salt of vanadomolybdophosphoric acid, lithium salt of vanadomolybdosilicic acid, sodium salt of vanadomolybdosilicic acid, copper salt of vanadomolybdosilicic acid, gold salt of vanadomolybdosilicic acid and gallium salt of vanadomolybdosilicic acid.

Among these, preferred are lithium salt of tungstosilicic acid, sodium salt of tungstosilicic acid, copper salt of tungstosilicic acid, gold salt of tungstosilicic acid, gallium salt of tungstosilicic acid, lithium salt of tungstophosphoric acid, sodium salt of tungstophosphoric acid, copper salt of tungstophosphoric acid, gold salt of tungstophosphoric acid, gallium salt of tungstophosphoric acid, lithium salt of molybdophosphoric acid, sodium salt of molybdophosphoric acid, copper salt of molybdophosphoric acid, gold salt of molybdophosphoric acid, gallium salt of molybdophosphoric acid, lithium salt of molybdosilicic acid, sodium salt of molybdosilicic acid, copper salt of molybdosilicic acid, gold salt of molybdosilicic acid, gallium salt of molybdosilicic acid, lithium salt of vanadotungstosilicic acid, sodium salt of vanadotungstosilicic acid, copper salt of vanadotungstosilicic acid, gold salt of vanadotungstosilicic acid, gallium salt of vanadotungstosilicic acid, lithium salt of vanadotungstophosphoric acid, sodium salt of vanadotungstophosphoric acid, copper salt of vanadotungstophosphoric acid, gold salt of vanadotungstophosphoric acid and gallium salt of vanadotungstophosphoric acid.

More preferred are lithium salt of tungstosilicic acid, sodium salt of tungstosilicic acid, copper salt of tungstosilicic acid, gold salt of tungstosilicic acid, gallium salt of tungstosilicic acid, lithium salt of tungstophosphoric acid, sodium salt of tungstophosphoric acid, copper salt of tungstophosphoric acid, gold salt of tungstophosphoric acid, gallium salt of tungstophosphoric acid, lithium salt of vanadotungstosilicic acid, sodium salt of vanadotungstosilicic acid, copper salt of vanadotungstosilicic acid, gold salt of vanadotungstosilicic acid, gallium salt of vanadotungstosilicic acid, lithium salt of vanadotungstophosphoric acid, sodium salt of vanadotungstophosphoric acid, copper salt of vanadotungstophosphoric acid, gold salt of vanadotungstophosphoric acid and gallium salt of vanadotungstophosphoric acid.

The method for loading a heteropolyacid salt on a support roughly includes the following three methods (1) to (3):

(1) a method of loading a desired heteropolyacid on a support and then loading a starting material for the desired element for forming a salt,

(2) a method of loading a desired heteropolyacid and a starting material for the element of forming a salt, together on a support or loading a previously prepared heteropolyacid salt, and

(3) a method of previously loading a starting material for the element for forming a salt on a support and then loading a desired heteropolyacid.

In any of these methods (1) to (3), the heteropolyacid, a salt thereof and the starting material for the element of forming a salt each can be loaded on a support after dissolving it or suspending it in an appropriate solvent. The solvent may be any solvent as long as it can uniformly dissolve or suspend the desired heteropolyacid, a salt thereof and the starting material for the element of forming a salt, and examples of the solvent which can be used include water, an organic solvent and a mixture thereof. Among these, preferred are water, alcohol and carboxylic acid.

The method for dissolving or suspending the desired heteropolyacid, a salt thereof and the starting material for the element of forming a salt may also be any method as long as it can uniformly dissolve or suspend the materials. In the case of a free acid, a free acid which can dissolve may be dissolved as it is in a solvent and even in the case of a free acid which cannot completely dissolve, if the free acid can be uniformly suspended by forming it into fine powder, the free acid may be suspended as such.

In the method (1), a solution or suspension obtained by dissolving or suspending a heteropolyacid in a solvent is absorbed into a support to thereby load the heteropolyacid on the support and then, a solution or suspension of a starting material for the element of forming a desired salt is absorbed into the support to thereby load the element. At this time, a neutralization reaction proceeds on the support and, as a result, a catalyst having supported thereon a heteropolyacid salt can be prepared.

In the method (2), a heteropolyacid and a starting material for the element of forming a salt are dissolved or suspended together or these are dissolved or suspended separately and then mixed, and the thus-prepared solution or suspension is absorbed into a support and thereby loaded on the support. If the compound is in the state of a heteropolyacid salt, a uniform solution or suspension may be obtained in the same manner as in the case of a free acid.

In the method (3), a solution or suspension of a starting material for the element of forming a salt is previously prepared, the solution or suspension is absorbed into a support to thereby load the element, and then a desired heteropolyacid is loaded thereon. This method includes a method of using an element which is previously contained in the support and can form a heteropolyacid salt.

More specifically, a part or all of the elements previously contained in a support sometimes act to form a salt of a heteropolyacid on loading and, as a result, a heteropolyacid salt is formed. Examples of such an element include potassium, sodium, calcium, iron, magnesium, titanium and aluminum, however, the present invention is not limited thereto.

The kind of the element previously contained in a support and the amount thereof can be measured by chemical analysis such as ICP, fluorescent x-ray spectrometry and atomic absorption spectrometry. The kind and the amount of the element vary depending on the support, however, potassium, sodium, calcium, iron, magnesium, titanium and ammonium are sometimes contained in a relatively large amount and the content thereof is approximately from 0.001 to 5.0% by mass. Therefore, depending on the combination of a support and a heteropolyacid, the element may be previously contained in the support in an amount large enough to form a salt, though this may vary depending on the kind and the amount of the heteropolyacid supported.

The amount of a heteropolyacid salt supported is preferably from 10 to 150% by mass, more preferably from 30 to 100% by mass, based on the total weight of the support. If the heteropolyacid salt content is less than 10% by mass, the active component content of the catalyst is too small and the activity per unit weight of catalyst may disadvantageously decrease. If the heteropolyacid salt content exceeds 150% by mass, the effective pore volume decreases and, as a result, the effect of the increase in the supported amount may not be brought out and, at the same time, coking is disadvantageously liable to occur to seriously shorten the catalyst life.

The method for loading a solution or suspension of a heteropolyacid and/or a heteropolyacid salt on a support is not particularly limited and a known method may be used. More specifically, for example, the catalyst may be prepared by dissolving a heteropolyacid in distilled water corresponding to the liquid absorption amount of a support used and impregnating the solution into the support. Also, the catalyst may be prepared by using an excess aqueous solution, dipping a support in the heteropolyacid solution while appropriately moving the support and then removing the excess acid through filtration. The volume of the solution or suspension used at this time varies depending on the support or loading method used.

The thus-obtained wet catalyst is suitably dried by placing it in a heating oven for a few hours. The drying method is not particularly limited and any method such as standing or belt conveyor may be used. After the drying, the catalyst is cooled to the ambient temperature in a desiccator so as not to absorb moisture.

The amount of a heteropolyacid and/or a heteropolyacid salt supported in the thus-obtained heteropolyacid salt supported catalyst can be simply calculated by subtracting the weight of the support used from the weight after drying of the catalyst prepared. To be more exact, the supported amount can be determined by chemical analysis such as ICP, fluorescent X-ray spectrometry and atomic absorption spectrometry.

The catalyst for producing a lower aliphatic carboxylic acid ester of the present invention is preferably produced by a production process comprising a first step of loading at least one member selected from the group consisting of heteropolyacids and salts thereof on a support of the present invention to obtain a catalyst, and a second step of contacting this catalyst with a gas containing at least one member selected from the group consisting of water, lower aliphatic carboxylic acids and lower aliphatic alcohols to obtain a catalyst for the production of a lower aliphatic carboxylic acid ester.

In this method, the loading of a heteropolyacid and/or a heteropolyacid salt on a support in the first step can be performed according to the method described in detail above.

The second step in the above-described production process is a step of contacting the catalyst having supported thereon a heteropolyacid and/or a heteropolyacid salt, which is obtained in the first step, with a gas containing at least one member selected from the group consisting of water, lower aliphatic carboxylic acids and lower aliphatic alcohols.

The method for contacting the supported catalyst obtained in the first step with a gas containing at least one member selected from the group consisting of water, lower aliphatic carboxylic acids and lower aliphatic alcohols is not particularly limited and, for example, the following methods may be used:

(a) a method of placing the catalyst, obtained in the first step, in an atmosphere of gas containing at least one member selected from the group consisting of water, lower aliphatic carboxylic acids and lower aliphatic alcohols;

(b) a method of passing the catalyst obtained in the first step, through a gas containing at least one member selected from the group consisting of water, lower aliphatic carboxylic acids and lower aliphatic alcohols; and

(c) a method of passing the catalyst obtained in the first step, through an atmosphere of gas containing at least one member selected from the group consisting of water, lower aliphatic carboxylic acids and lower aliphatic alcohols. These methods may be used in a combination of two or more thereof, if desired.

To speak more specifically regarding the method of performing the second step, for example, a method of filling the catalyst obtained in the first step into a vessel and contacting the above-described gas therewith, or a method of filling the catalyst obtained in the first step into, in place of the vessel, a reactor where the production process of a lower aliphatic carboxylic acid ester is performed later, and contacting the above-described gas therewith before feeding reaction starting materials, may be used. With respect to the shape of the vessel or the reactor used here, any shape such as vertical type or horizontal type may be used without any particular limit.

In view of the time period necessary for re-filling the catalyst or the vessel cost, the preferred embodiment of the second step includes a method of filling the catalyst obtained in the first step into a reactor which is used at the time of reacting a lower olefin with a lower aliphatic carboxylic acid in a gas phase to produce a lower aliphatic carboxylic acid ester, and then contacting therewith a gas containing at least one member selected from the group consisting of water, lower aliphatic carboxylic acids and lower aliphatic alcohols before feeding the reaction starting materials. This method may be performed in either a closed circulatory system or a flow system.

The second step is preferably performed under a condition higher than the dew point of the gas containing at least one member selected from the group consisting of water, lower aliphatic carboxylic acids and lower aliphatic alcohols. If the condition is less than the dew point of this gas, a part of the gas may turn into a liquid. In this case, a heteropolyacid and/or a heteropolyacid salt supported on the catalyst in the first step, or other catalyst components supported if desired, may dissolve out to change the catalyst composition and in the worst case, the catalyst may be deactivated. Insofar as the catalyst is not adversely affected, the conditions in performing the second step are not particularly limited.

The preferred embodiment of a condition higher than the dew point of the above-described gas may vary depending on the composition of the gas or the pressure or the like in the practice, however, the contact temperature is preferably from 80 to 300° C., more preferably from 100 to 260° C.

The contact pressure is not particularly limited and may be either normal pressure or an applied pressure. The contact pressure is preferably from 0 to 3 MPaG (gauge pressure), more preferably from 0 to 2 MPaG (gauge pressure).

The lower aliphatic carboxylic acid in the gas containing at least one member selected from the group consisting of water, lower aliphatic carboxylic acids and lower aliphatic alcohols used in the second step is preferably a lower aliphatic carboxylic acid having from 1 to 6 carbon atoms. Specific examples thereof include formic acid, acetic acid, propionic acid, n-butyric acid and isobutyric acid. Among these, preferred are acetic acid and propionic acid.

The lower aliphatic alcohol in the gas containing at least one member selected from the group consisting of water, lower aliphatic carboxylic acids and lower aliphatic alcohols used in the second step is preferably a lower aliphatic alcohol having from 1 to 6 carbon atoms. Specific examples thereof include methanol, ethanol, 1-propanol, 2-propanol, 1-butanol and 2-butanol. Among these, particularly preferred are methanol, ethanol and n-propanol.

The composition of the gas containing at least one member selected from the group consisting of water, lower aliphatic carboxylic acids and lower aliphatic alcohols used in the second step is not particularly limited, and water, a lower aliphatic carboxylic acid and/or a lower aliphatic alcohol can be mixed at an arbitrary ratio. The composition is preferably such that water:lower aliphatic carboxylic acid:lower aliphatic alcohol=1.0:0.1 to 10.0:0.1 to 5.0 in terms of the molar ratio. The composition of the gas may be constant from the beginning to the end of contacting or may be changed according to the contact time or the stage of contacting.

The gas containing at least one member selected from the group consisting of water, lower aliphatic carboxylic acids and lower aliphatic alcohols used in the second step is more preferably water alone or a mixed gas of water and acetic acid, still more preferably a mixed gas of water and acetic acid, because a predetermined effect can be obtained within a short period of time. In the case of using a mixed gas of water and acetic acid, the composition thereof is not particularly limited but preferably such that water : acetic acid=1.0:0.1 to 10.0, more preferably water : acetic acid=1.0:0.5 to 5.0, in terms of the molar ratio.

The gas hourly space velocity (GHSV) of the gas, which is the speed of feeding the gas in performing the contact with a gas containing at least one member selected from the group consisting of water, lower aliphatic carboxylic acids and lower aliphatic alcohols in the second step, is not particularly limited. The GHSV is preferably from 100 to 7,000 hr⁻¹, more preferably from 300 to 3,000 hr⁻¹. If the GHSV is too high, the amount of the gas used increases and this is not preferred in view of the cost. From this standpoint, the contacting may also be performed in the state such that the gas is fed in a constant amount and enclosed in a vessel.

The contact time is not particularly limited but preferably from 0.5 to 200 hours, more preferably from 0.5 to 100 hours, and most preferably from 0.5 to 50 hours. The optimal contact time varies depending on the composition and concentration of the gas, the temperature and pressure at the contacting, and the catalyst components.

Generally, if the contact time is less than 0.5 hours, the effect of the second step may not be fully brought out, whereas if the contact time is prolonged, the effect is liable to increase, however, even if the contact time is prolonged to exceed 200 hours, the effect does not increase any more and, moreover, in the case where gas is contacted in the flowing state, the amount of the gas used increases and this is not preferred in view of the profitability.

These first and second steps may be performed either continuously or completely independently of each other. More specifically, for example, after purchasing the catalyst passed through the first step, the second step may be performed using this catalyst.

Furthermore, in the process for producing the catalyst for producing a lower aliphatic carboxylic acid ester according to the present invention, other steps may be provided, if desired. Such a step may be performed before, after or during the loading of a heteropolyacid and/or a heteropolyacid salt on a support, before the first step, between the first step and the second step, after the second step, or at any stage during these steps.

Examples of other steps performed if desired include a step of loading a third component having a purpose of more improving the catalyst performance. In this case, if possible, this loading operation and the operation of loading a heteropolyacid and/or a heteropolyacid salt be performed simultaneously. Furthermore, further contact with another gas may also be performed after the contact with the gas containing at least one member selected from the group consisting of water, lower aliphatic carboxylic acids and lower aliphatic alcohols.

The present invention also provides a process for producing a lower aliphatic carboxylic acid ester, comprising reacting a lower olefin with a lower aliphatic carboxylic acid in a gas phase in the presence of the catalyst for producing a lower aliphatic carboxylic acid ester of the present invention.

In practicing this process, the reaction form of the gas phase reaction is not particularly limited and any form such as fixed bed system and fluidized bed system may be employed. With respect to the shape of the support governing the shape and size of the catalyst, as described above, any desired shape can be selected according to the reaction form practiced.

Examples of the lower olefin which can be used in the process for producing a lower aliphatic carboxylic acid ester of the present invention include ethylene, propylene, n-butene, isobutene and a mixture of two or more thereof.

The lower aliphatic carboxylic acid is suitably a carboxylic acid having from 1 to 4 carbon atoms and specific examples thereof include formic acid, acetic acid, propionic acid, butyric acid, acrylic acid and methacrylic acid.

The proportion between the lower olefin and the lower aliphatic carboxylic acid used as the starting materials is not particularly limited. In view of the conversion of the lower olefin, the lower olefin is preferably used in an equimolar or excess molar amount to the lower aliphatic carboxylic acid. To speak specifically, the molar ratio of the lower olefin to the lower aliphatic carboxylic acid is preferably in the range of lower olefin : lower aliphatic carboxylic acid=from 1:1 to 30:1, more preferably from 3:1 to 20:1, still more preferably from 5:1 to 15:1.

In the process for producing a lower aliphatic carboxylic acid ester of the present invention, a slight amount of water is preferably added to the starting materials comprising a lower olefin and a lower aliphatic carboxylic acid from the standpoint of maintaining the catalytic activity. However, if an excessively large amount of water is added, the amount of by-products such as alcohol and ether disadvantageously increases. The amount of water added is preferably, in terms of the molar ratio of water to the sum total of lower olefin and lower aliphatic monocarboxylic acid as starting materials and water added, from 0.5 to 15 mol %, more preferably from 2 to 8 mol %.

In this process, preferred reaction conditions such as temperature and pressure vary depending on the kinds of the lower olefin and lower aliphatic carboxylic acid used as the starting materials. The reaction conditions such as temperature and pressure are preferably combined so that the starting materials can each be kept in the gas state and the reaction can satisfactorily proceed. In general, the temperature is preferably from 120 to 300° C., more preferably from 140 to 250° C. The pressure is preferably from 0 to 3 MPaG (gauge pressure), more preferably from 0 to 2 MPaG (gauge pressure).

The each starting material is not particularly limited regarding the GHSV, however, if the GHSV is excessively high, the starting materials pass through before the reaction satisfactorily proceeds, whereas if it is too low, there may arise problems such as reduction in the productivity. The GHSV is preferably from 100 to 7,000 hr⁻¹, more preferably from 300 to 3,000 hr⁻¹.

The unreacted lower olefin, and also the alcohol and the ether as by-products in the reaction may be recycled and used as they are. At this time, substances harmful to the catalyst for the production of a lower aliphatic carboxylic acid ester, such as butene and aldehyde, are difficult to separate from olefin, alcohol, ether and the like and may be sent to the reactor. If this is so, the catalyst performance may be seriously reduced or the life thereof may be extremely shortened. Accordingly, a catalyst, for producing a lower aliphatic carboxylic acid ester of the present invention, and which can greatly reduce the production of these by-products at the reaction stage, is used. The process for producing a lower aliphatic carboxylic acid ester of the present invention is effective particularly when the above-described recycling system is included in the production process.

The present invention will be further illustrated below by referring to the Examples and Comparative Examples, however, these examples are described to show the outline of the present invention and the present invention should not be construed as being limited thereto.

In the examples, the measured values were obtained by analysis or measurement performed according to the following methods.

Analysis Method of Contents of Silicon and Other Elements in Support:

A support was weighed to 1 g and 10 ml of 50% HF (aqueous hydrofluoric acid solution) was added. In this liquid, a sample was dissolved. When an undissolved portion was present, a pressure acidolysis was further performed at 200° C. for 4 hours and thereby, the sample was completely dissolved. This sample solution was appropriately diluted by adding distilled water thereto and quantitated by induction coupled plasma emission spectrometry-mass spectrometry (ICP-MS).

Analysis Method of Silicon Content of Support in Catalyst

This was analyzed according to the above-described analysis method for the silicon content in the support. However, in the case of compounds containing silicon as the heteropolyacid of the catalyst component, such as tungstosilicic acid, the silicon content thereof can be determined by extracting only the heteropolyacid through water extraction and measuring the purity of the support.

Measuring Method of Crush Strength

This was measured according to JIS Z 8841 “Granulate-Strength Test Method”.

Here, the crack ratio of the support was determined as follows. After drying 100 mL of a support at 110° C. for 4 hours, the support was placed in a desiccator and allowed to cool to room temperature. Into a 1 L beaker containing 500 mL of distilled water, 50 mL of the cooled support was charged and after 30 minutes, the proportion of cracked support to non-cracked supports was determined. The obtained value was shown by %.

### EXAMPLES 1 TO 7 AND COMPARATIVE EXAMPLES 1 TO 6

Support:

The following supports were used.

Support 1:

Natural silica (KA-0, produced by SUD-CHEMIE CATALYSTS JAPAN, INC.)

Specific surface area: 103.7 m²/g

Pore volume: 0.33 cm³/g

Crush strength: 62 N

Support 2:

Natural silica (KA-1, produced by SUD-CHEMIE CATALYSTS JAPAN, INC.)

Specific surface area: 110.8 m²/g

Pore volume: 0.42 cm³/g

Crush strength: 84 N

Support 3:

Natural silica (KA-160, produced by SUD-CHEMIE CATALYSTS JAPAN, INC.)

Specific surface area: 158.1 m²/g

Pore volume: 0.42 cm³/g

Crush strength: 71 N

Support 4:

Synthetic silica (N602T, produced by NIKKI CHEMICAL CO., LTD.)

Specific surface area: 132 m²/g

Pore volume: 0.7 cm³/g

Crush strength: 30 N

Support 5:

Synthetic silica (CARIACT Q-10, produced by FUJI SILYSIA CHEMICAL LTD.)

Specific surface area: 309 m²/g

Pore volume: 1.02 cm³/g

Crush strength: 20 N

Support 6:

Synthetic silica (Grace 57, produced by Grace Devison K. K.)

Specific surface area: 430 m²/g

Pore volume: 1.0 cm³/g

Crush strength: 13 N

Support 7:

Silica-alumina (N631L, produced by NIKKI CHEMICAL CO., LTD.)

Specific surface area: 480 m²/g

Pore volume: 0.18 cm³/g

Crush strength: 1900 N

These supports each was analyzed on the contents of elements. The obtained content as an oxide of each element is shown in Table 1.

Furthermore, the crack ratio of each support is shown in Table 2.

TABLE 1

| | SiO₂ | K₂O | Na₂O | Fe₂O₃ | Al₂O₃ | Others |
|---|---|---|---|---|---|---|
| Support 1 | 96.04 | 0.657 | 1.389 | 0.229 | 0.762 | 0.928 |
| Support 2 | 93.11 | 0.843 | 1.587 | 0.356 | 1.923 | 2.185 |
| Support 3 | 95.60 | 0.778 | 1.046 | 0.132 | 0.698 | 1.750 |
| Support 4 | 98.44 | 0.502 | 0.423 | 0.120 | 0.275 | 0.236 |
| Support 5 | 99.54 | 0.172 | 0.077 | 0.045 | 0.027 | 0.140 |
| Support 6 | 99.71 | 0.105 | 0.105 | 0.049 | 0.032 | 0.002 |
| Support 7 | 81.60 | 0.256 | 0.018 | 0.042 | 12.600 | 5.480 |

unit: wt %

TABLE 2

| | Crack Ratio (%) |
|---|---|
| Support 1 | <1.0 |
| Support 2 | <1.0 |
| Support 3 | <1.0 |
| Support 4 | <1.0 |
| Support 5 | 10.0 |
| Support 6 | 15.0 |
| Support 7 | <1.0 |

Production Operation of Catalyst:

Using each of those supports, catalysts were produced as follows.

Supports 1 to 7 were each preliminarily dried for 4 hours in a (hot-air type) drier previously adjusted to 110° C. After the preliminary drying, each support was measured for the bulk density using a 1 liter measuring cylinder. A predetermined amount of tungstosilicic acid was weighed and after adding thereto 15 ml of distilled water, uniformly dissolved. Furthermore, distilled water was added to make an amount described in the column of Prepared Liquid Volume of Table 3. Thereafter, the preliminarily dried support was weighed to a weight described in the column of Support Weight of Table 3, added to the impregnating solution and impregnated therewith while thoroughly stirring. The support impregnated with the solution was transferred to a porcelain dish, air-dried for 1 hour and then dried in a hot-air type drier adjusted to 150° C. for 5 hours. After the drying, the catalyst was transferred to a desiccator and allowed to cool to room temperature. The thus-obtained catalyst was weighed. Further, the crush strength and crack ratio were measured.

The obtained characteristic data of each catalyst are shown in Table 3.

TABLE 3

| | | | | | Amount of | | | | |
|---|---|---|---|---|---|---|---|---|---|
| | | Bulk | Weight | | Catalyst | Prepared | | | |
| | | Density of | of | | Component | Liquid | Dry | Crush | |
| Catalyst | Support | Support | Support | Catalyst | Supported | Volume | Weight | Strength | Crack Ratio |
| No. | No. | (g/L) | (g) | Component | (g/L) | (ml) | (g) | (N) | (%) |
| 1 | 1 | 558 | 55.8 | Li_{0.01}H_{3.99}SiW₁₂O₄₀ | 300 | 34 | 86.2 | 60 | <1.0 |
| 2 | 1 | 558 | 55.8 | Li_{0.1}H_{2.9}PW₁₂O₄₀ | 550 | 34 | 110.5 | 66 | <1.0 |
| 3 | 2 | 573 | 57.3 | Li_{0.01}H_{3.99}SiW₁₂O₄₀ | 300 | 33 | 87.1 | 81 | <1.0 |
| 4 | 3 | 575 | 57.5 | H₄SiW₁₂O₄₀ | 300 | 33 | 87.9 | 70 | <1.0 |
| 5 | 3 | 575 | 57.5 | Li_{0.001}H_{2.999}PW₁₂O₄₀ | 300 | 34 | 88.1 | 69 | <1.0 |
| 6 | 4 | 448 | 44.8 | Li_{0.1}H_{2.9}PW₁₂O₄₀ | 400 | 41 | 85.2 | 28 | <1.0 |
| 7 | 5 | 456 | 45.6 | Li_{0.1}H_{3.9}SiW₁₂O₄₀ | 300 | 43 | 75.9 | 16 | 8.2 |
| 8 | 5 | 456 | 45.6 | H₃PW₁₂O₄₀ | 350 | 43 | 80.9 | 17 | 8.9 |
| 9 | 6 | 413 | 41.3 | Li_{0.1}H_{3.9}SiW₁₂O₄₀ | 300 | 50 | 71.0 | 12 | 14.2 |
| 10 | 6 | 413 | 41.3 | Li_{0.1}H_{3.9}SiW₁₂O₄₀ | 350 | 50 | 76.2 | 11 | 15.6 |
| 11 | 7 | 607 | 60.7 | H₃PW₁₂O₄₀ | 300 | 33 | 90.5 | 1800 | <1.0 |

Production Operation of Carboxylic Acid Ester

Into a pressure-resistant vessel made of SUS316L, 40 ml of each catalyst obtained above was filled, and a reaction was carried out under the conditions in the column of Pre-Treatment Conditions and the column of Ethyl Acetate Production Conditions. The gas passed through the catalyst layer was cooled and collected under ice cooling for a predetermined time and the entire amount was recovered (this is called a condensed solution) and analyzed. The outlet gas remaining uncondensed (this is called an uncondensed gas) was measured on the gas flow rate for the same predetermined time as in the condensed solution and then 50 ml of the uncondensed gas was sampled and analyzed.

The results obtained are shown in Tables 4 and 5.

TABLE 4

| | | | | | | | | | | | Reaction Results | | |
|---|---|---|---|---|---|---|---|---|---|---|---|---|---|
| | | Pre-Treatment Conditions | | | | | Ethyl Acetate Production Conditions | | | | | | Selec- |
| Ex- | | Treated Gas | | | Tem- | | Composition of | | | | Reac- | Ethyl | tivity |
| am- | Cata- | Composition | Gas Flow | | pera- | | Starting Gases | Gas Flow | | Tempera- | tion | Acetate | of |
| ple | lyst | HOAc:H₂O | Rate | Pressure | ture | Time | C₂H₄:HOAc:H₂O:N₂ | Rate | Pressure | ture | Time | STY | Butene |
| No. | No. | (molar ratio) | (NL/hr) | (MPaG) | (° C.) | (hr) | (molar ratio) | (NL/hr) | (MPaG) | (° C.) | (hr) | (g/L · hr) | (%) |
| 1 | 1 | none | — | — | — | — | 78.5:8:4.5:9 | 60 | 0.8 | 165 | 5 | 181 | 0.01 |
| 2 | 2 | none | — | — | — | — | 70:8:4:18 | 60 | 0.6 | 165 | 5 | 186 | 1.97 |
| 3 | 3 | none | — | — | — | — | 70:8:4:18 | 40 | 1.0 | 165 | 5 | 184 | 0.21 |
| 4 | 4 | none | — | — | — | — | 70:8:4:18 | 80 | 0.8 | 165 | 5 | 187 | 1.19 |
| 5 | 5 | none | — | — | — | — | 78.5:8:4.5:9 | 60 | 0.6 | 165 | 5 | 174 | 1.27 |
| 6 | 6 | none | — | — | — | — | 70:8:3:19 | 60 | 0.8 | 170 | 5 | 190 | 2.34 |
| 7 | 2 | 6:6 | 60 | 0.8 | 165 | 12 | 78.5:8:4.5:9 | 60 | 0.8 | 165 | 5 | 208 | 0.22 |
| 8 | 5 | 6:6 | 60 | 0 | 165 | 12 | 78.5:8:4.5:9 | 60 | 0.8 | 165 | 5 | 205 | 0.26 |

TABLE 5

| | | | | | | | | | | | Reaction Results | | |
|---|---|---|---|---|---|---|---|---|---|---|---|---|---|
| | | Pre-Treatment Conditions | | | | | Ethyl Acetate Production Conditions | | | | | | Selec- |
| Compara- | | Treated Gas | | | Tem- | | Composition of | | | Tem- | Reac- | Ethyl | tivity |
| tive | Cata- | Composition | Gas Flow | | pera- | | Starting Gases | Gas Flow | | pera- | tion | Acetate | of |
| Example | lyst | HOAc:H₂O | Rate | Pressure | ture | Time | C₂H₄:HOAc:H₂O:N₂ | Rate | Pressure | ture | Time | STY | Butene |
| No. | No. | (molar ratio) | (NL/hr) | (MPaG) | (° C.) | (hr) | (molar ratio) | (NL/hr) | (MPaG) | (° C.) | (hr) | (g/L · hr) | (%) |
| 1 | 7 | none | — | — | — | — | 78.5:8:4.5:9 | 60 | 0.8 | 165 | 5 | 254 | 0.22 |
| 2 | 8 | none | — | — | — | — | 70:8:4:18 | 60 | 0.6 | 165 | 5 | 250 | 0.14 |
| 3 | 9 | none | — | — | — | — | 70:8:4:18 | 40 | 1.0 | 165 | 5 | 244 | 0.12 |
| 4 | 10 | none | — | — | — | — | 70:8:4:18 | 80 | 0.8 | 165 | 5 | 260 | 0.13 |
| 5 | 11 | none | — | — | — | — | 78.5:8:4.5:9 | 60 | 0.6 | 165 | 5 | 12 | 0.00 |
| 7 | 8 | 6:6 | 60 | 0.8 | 165 | 12 | 78.5:8:4.5:9 | 60 | 0.8 | 165 | 5 | 254 | 0.12 |
| 8 | 10 | 6:6 | 60 | 0 | 165 | 12 | 78.5:8:4.5:9 | 60 | 0.8 | 165 | 5 | 273 | 0.08 |

Analysis Method for Condensed Solution:

An analysis solution was prepared by adding 1 ml of 1,4-dioxane as the internal standard to 10 ml of the reaction solution, 0.4 μl of the analysis solution was injected, and the analysis was performed using the internal standard method under the following conditions.

Gas chromatography:

GC-14B, Manufactured by Shimadzu Corporation Column:

capillary column TC-WAX (length: 30 m, internal diameter: 0.25 mm, film thickness: 0.25 μm)

Carrier Gas:

nitrogen (split ratio: 20, column flow rate: 1 ml/min)

Temperature Conditions:

The detector and the vaporization chamber were at a temperature of 200° C. and the column temperature was kept at 40° C. for 7 minutes from the initiation of analysis, thereafter elevated up to 230° C. at a temperature rising rate of 10° C./min, and kept at 230° C. for 5 minutes.

Detector:

FID (H₂ pressure: 70 KPa, air pressure: 100 KPa)

Analysis Method for Uncondensed Gas:

Using an absolute calibration curve method, the analysis was performed under the following conditions by sampling 50 ml of the effluent gas and passing the whole amount thereof into a 1 ml-volume gas sampler attached to the gas chromatograph.

1. Ether, Carboxylic Acid Ester, Alcohol and Trace By-Products

Gas Chromatograph:

gas chromatograph (GC-14, manufactured by Shimadzu Corporation) with a gas sampler for Shimadzu gas chromatograph (MGS-4, measuring tube: 1 ml)

Column:

packed column SPAN 80, 15% Shinchrom A of 60 to 80 mesh (length: 5 m)

Carrier Gas:

nitrogen (flow rate: 25 ml/min)

Temperature Conditions:

the detector and the vaporization chamber were at a temperature of 120° C., and the column temperature was 65° C. and constant.

Detector:

FID (H₂ pressure: 60 KPa, air pressure: 100 KPa)

2. Butene:

Gas chromatograph:

gas chromatograph (GC-14B, manufactured by Shimadzu Corporation) with a gas sampler for Shimadzu gas chromatograph (MGS-4, measuring tube: 1 ml)

Column:

packed column Unicarbon A-400 of 80/100 mesh, length: 2 m

Carrier gas:

helium (flow rate: 23 ml/min)

Temperature Conditions:

the detector and the vaporization chamber were at a temperature of 130° C., and the column temperature was elevated from 40° C. to 95° C. at a temperature rising rate of 40° C./min.

Detector:

FID (H₂ pressure: 70 KPa, air pressure: 100 KPa)

3. Ethylene:

Gas Chromatograph:

gas chromatograph (GC-14B, manufactured by Shimadzu Corporation) with a gas sampler for Shimadzu gas chromatograph (MGS-4, measuring tube: 1 ml)

Column:

packed column Unibeads IS, length: 3 m

Carrier Gas:

helium (flow rate: 20 ml/min)

Temperature Conditions:

the detector and the vaporization chamber were at a temperature of 120° C., and the column temperature was 65° C. and constant.

Detector:

TCD (He pressure: 70 KPa, current: 90 mA, temperature: 120° C.)

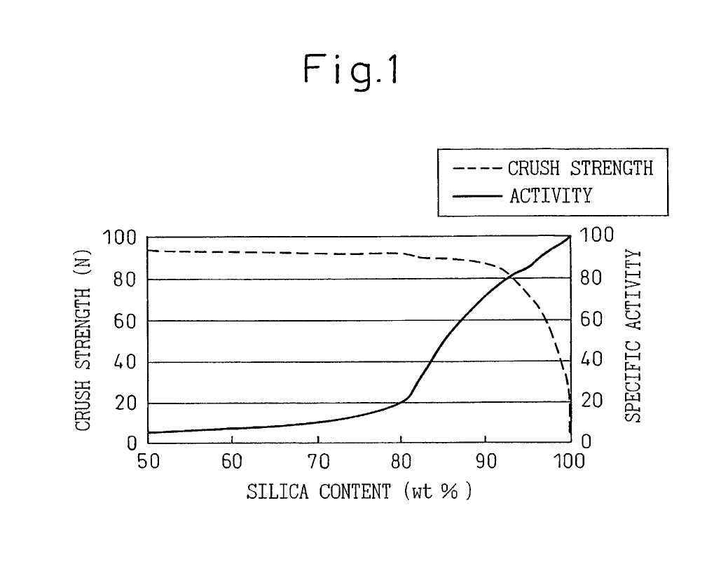

FIG. 1 is a graph where based on the results above, the crush strength (N) of the catalyst support and the specific activity of the catalyst are plotted with respect to the silica content (wt %). It is seen from FIG. 1 that when the silicon content of the siliceous support according to the present invention is in the range of 85 to 99% by mass in terms of silica, the obtained catalyst can have high strength and high activity.

### INDUSTRIAL APPLICABILITY

According to the present invention, at the time of producing a lower aliphatic carboxylic acid ester by reacting a lower olefin with a lower aliphatic monocarboxylic acid in a gas phase, a catalyst having a silicon content in a predetermined range is used as the siliceous support of the catalyst for the production, whereby a catalyst having predetermined strength and exhibiting performances of a predetermined level can be obtained and the production operation can be stably performed without causing cracking or abrasion of the catalyst even in long-term use.

1. A siliceous support for use in a catalyst for producing a lower aliphatic carboxylic acid ester by reacting a lower olefin with a lower aliphatic carboxylic acid in a gas phase, which has a silicon content of from 39.7 to 46.3% by mass

2. A siliceous support for use in a catalyst for producing a lower aliphatic carboxylic acid ester by reacting a lower olefin with a lower aliphatic carboxylic acid in a gas phase, which has a silicon content of from 85 to 99% by mass in terms of silicon dioxide.

3. A siliceous support for use in a catalyst for producing a lower aliphatic carboxylic acid ester by reacting a lower olefin with a lower aliphatic carboxylic acid in a gas phase, which has a crush strength of 30 N or more.

4. A catalyst for producing a lower aliphatic carboxylic acid ester by reacting a lower olefin with a lower aliphatic carboxylic acid in a gas phase, comprising a support as claimed in any one of claims 1 to 3.

5. A catalyst according to claim 4, which has a crush strength of 30 N or more.

6. A catalyst according to claim 4 or 5, wherein at least one member selected from the group consisting of heteropolyacids and salts thereof is supported on the support.

7. A catalyst according to claim 6, wherein the heteropolyacids are selected from the group consisting of tungstosilisic acid, tungstophosphoric acid, molybdophosphoric acid, molybdosilisic acid, vanadotungstosilisic acid, vanadotungstophosphoric acid, vanadomolybdophosphoric acid, vanadomolybdosilisic acid, molybdotungstosilisic acid and molybdotungstophosphoric acid.

8. A catalyst according to claim 6 or 7, wherein the heteropolyacid salts are selected from the group consisting of lithium, sodium, magnesium, barium, copper, gold and gallium salts of tungstosilisic acid, tungstophosphoric acid, molybdophosphoric acid, molybdosilisic acid, vanadotungstosilisic acid, vanadotungstophosphoric acid, vanadomolybdophosphoric acid, vanadomolybdosilisic acid, molybdotungstosilisic acid and molybdotungstophosphoric acid.

9. A process for producing a catalyst as claimed in any one of claims 4 to 8, comprising loading at least one member selected from the group consisting of heteropolyacids and salts thereof on a support as claimed in any one of claims 1 to 3.

10. A process for producing a catalyst as claimed in any one of claims 4 to 8, comprising the following first and second steps:
First Step:
a step of loading at least one member selected from the group consisting of heteropolyacids and salts thereof on a support as claimed in any one of claims 1 to 3 to obtain a heteropolyacid and/or heteropolyacid salt-supported catalyst; and
Second Step:
A step of contacting the heteropolyacid and/or heteropolyacid salt-supported catalyst obtained in the first step with a gas containing at least one member selected from the group consisting of water, lower aliphatic carboxylic acids and lower aliphatic alcohols to obtain a catalyst for producing a lower aliphatic carboxylic acid ester.

11. A process according to claim 10, wherein the gas containing at least one member selected from the group consisting of water, lower aliphatic carboxylic acids and lower aliphatic alcohols is a mixed gas of water and acetic acid.

12. A process for producing a lower aliphatic carboxylic acid ester, comprising reacting a lower olefin with a lower aliphatic carboxylic acid in a gas phase in the presence of a catalyst as claimed in any one of claims 4 to 8.

13. A process according to claim 12, wherein the reaction of a lower olefin with a lower aliphatic carboxylic acid is carried out in the presence of water.
